(19) United States
(12) Patent Application Publication
(10) Pub. No.: US 2021/0370421 A1
(43) Pub. Date: Dec. 2, 2021

(54) DEVICE FOR CUTTING SHEET METAL

(71) Applicant: ASCO Biegetechnik GmbH, Bischofswiensen (DE)

(72) Inventor: Sylvio MATTÄß, Bayerisch Gmain (DE)

(73) Assignee: ASCO Biegetechnik GmbH, Bischofswiensen (DE)

(21) Appl. No.: 16/979,006

(22) PCT Filed: Oct. 17, 2019
(86) PCT No.: PCT/EP2019/078251

§ 371 Date: Sep. 8, 2020

(30) Foreign Application Priority Data
Oct. 18, 2018 (DE) 10 2018 217 906.9

(51) Int. Cl. B23D 35/00; B23D 19/04; B23D 15/08

(52) U.S. Cl. CPC B23D 35/007; B23D 15/08; B23D 19/04

(57) ABSTRACT

This application relates to a device for cutting sheet metal to provide a positive coupling between the cutting clearance and the immersion depth. The device includes a first circular blade having a first blade edge and a second circular blade having a second blade edge. The sheet metal to be cut is located between the first and the second circular blades during cutting. The first circular blade is rotatably mounted about a first axis of rotation and the second circular blade is rotatably mounted about a second axis of rotation which runs parallel to the first axis of rotation. A relative position of the first circular blade relative to the second circular blade can be adjusted. A distance between the first circular blade and the second circular blade is defined by a cutting clearance by which the first blade edge is axially spaced apart from the second blade edge in the direction of the first axis of rotation, and by an immersion depth by which the first blade edge and the second blade edge radially overlap each another in a direction perpendicular to the axes of rotation.

### I. FIELD OF APPLICATION

The present invention relates to a device for cutting sheet metal comprising a first and a second circular blade. It can be used in particular in connection with sheet metal bending machines, in which it cuts off the sheet metal to be bent before bending.

### II. TECHNICAL BACKGROUND

Devices for cutting sheet metal with two circular blades are already known in connection with sheet metal bending machines. In particular depending on the thickness of the sheet metal to be cut, it is necessary to adjust the relative position of the blade edges of the two circular blades relative to one another in order to achieve a qualitatively good cutting result. The parameters to be set are, firstly, the so-called cutting clearance by which the first blade edge is spaced apart from the second blade edge in the direction of the axis of rotation of the first circular blade, and secondly, the so-called immersion depth by which the first blade edge and the second blade edge radially overlap each other in a direction perpendicular to the axes of rotation of the circular blades.

In the known devices for cutting sheet metal, a first setting device for manually setting the cutting clearance and a second setting device for manually setting the immersion depth are provided. In this case, the setting of the cutting clearance and immersion depth parameters takes place independently of one another. In practice, this repeatedly results in poor cutting results, since the correlation between cutting clearance on the one hand and immersion depth on the other hand, which is required for a specific sheet metal thickness, is not set correctly. In addition, the independent operation of two setting devices represents a comparatively high set-up effort.

### III. DESCRIPTION OF THE INVENTION

### a) Technical Problem

The problem addressed by the present invention is therefore that of providing a device for cutting sheet metal with two circular blades which ensures that high-quality cutting results are achieved and, at the same time, is associated with the lowest possible set-up effort.

### b) Solution to the Problem

This problem is solved by means of a device with the features of claim 1. Further embodiments of the present invention result from the dependent claims.

According to the invention, a device for cutting sheet metal is proposed, comprising a first circular blade having a first blade edge and a second circular blade having a second blade edge, the sheet metal to be cut being located between the first circular blade and the second circular blade during cutting. The first circular blade is rotatably mounted about a first axis of rotation and the second circular blade is rotatably mounted about a second axis of rotation which runs parallel to the first axis of rotation. Both circular blades preferably roll passively about their relevant axis of rotation during the cutting process. A relative position of the first circular blade relative to the second circular blade can be adjusted. The relative position is defined on the one hand by a cutting clearance by which the first blade edge is axially spaced apart from the second blade edge in the direction of the first axis of rotation, and on the other hand by an immersion depth by which the first blade edge and the second blade edge radially overlap each other in a direction perpendicular to the axes of rotation. To adjust the aforementioned relative position, there is a positive coupling between the cutting clearance on the one hand and the immersion depth on the other hand such that, when a specific cutting clearance is set, a predetermined immersion depth is inevitably set and vice versa.

The positive coupling according to the invention is designed in such a way that each cutting clearance predetermined by a specific sheet metal thickness is assigned the immersion depth that matches the particular sheet metal thickness and vice versa. It is thereby achieved that only the cutting clearance parameter or the immersion depth parameter has to be set on the device according to the invention. The other parameter in question, either immersion depth or cutting clearance, is inevitably or automatically set. Since the correlation between the cutting clearance on the one hand and the immersion depth on the other hand is always taken into account for a specific sheet metal thickness, high-quality cutting results are always achieved with the device according to the invention. An incorrect setting of the required correlation between cutting clearance and immersion depth can no longer occur.

In the device according to the invention, the correlation between cutting clearance and immersion depth can be set, for example, by means of a CNC (computerised numerical control) controller. For example, it is possible to only input, into an input unit, the sheet metal thickness of the sheet metal to be cut if the correlation information which indicates what value the cutting clearance and immersion depth parameters should have for different sheet metal thicknesses that can be selected is stored in the CNC controller.

A mechanical positive coupling in the sense of the present invention can advantageously be achieved in that the first circular blade is rotatably mounted on a linearly movable eccentric element having an eccentric axis. The first axis of rotation has an eccentric offset relative to the eccentric axis. The eccentric element is provided with a thread which is concentric with the eccentric axis for linear movement of the eccentric element, wherein the thread can support itself against a counter thread of a housing of the device according to the invention. By rotating the eccentric element relative to the housing, the eccentric element can be moved linearly in order to set a specific cutting clearance. This inevitably involves rotating or pivoting the first axis of rotation about the eccentric axis, as a result of which a predetermined immersion depth is also set.

The geometric design of the eccentric offset on the one hand and the pitch of the thread on the other hand determines the correlation to be implemented by the positive coupling according to the invention between the cutting clearance and immersion depth parameters. The setting of a specific cutting clearance or a specific immersion depth always results in the optimal correlation of the cutting clearance and immersion depth for the predetermined sheet metal thickness.

The thread on the eccentric element, which supports itself against the housing of the device, is preferably an external thread. In a particularly advantageous manner, both a specific cutting clearance and the immersion depth associated with it can be set with the aid of a single servo motor which rotates the eccentric element. For this purpose, the servo motor can be in rotary connection with the eccentric element either permanently or only temporarily in order to adjust the relative position of the circular blades.

### c) Embodiment

An embodiment of the device according to the invention is described below by way of example with reference to the accompanying drawings, in which:

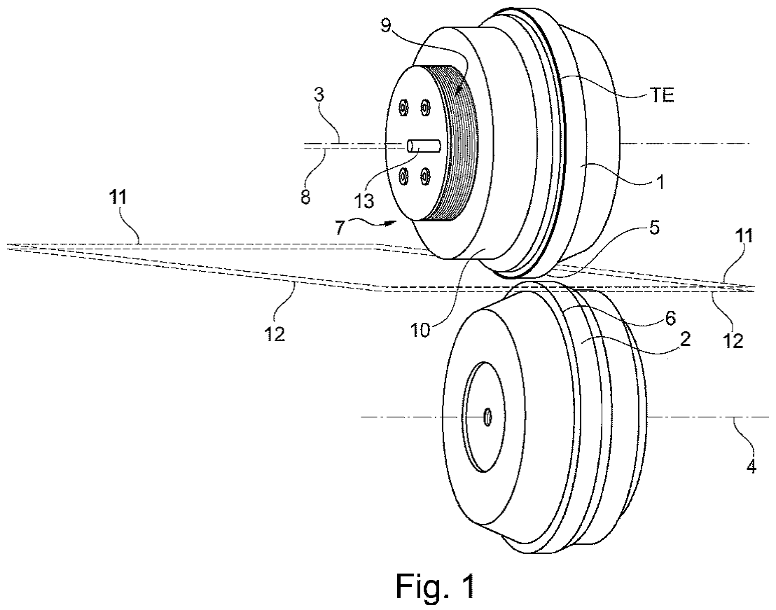

FIG. 1: is a schematic, perspective view of the first circular blade and the second circular blade of an embodiment of the device according to the invention in a first relative position;

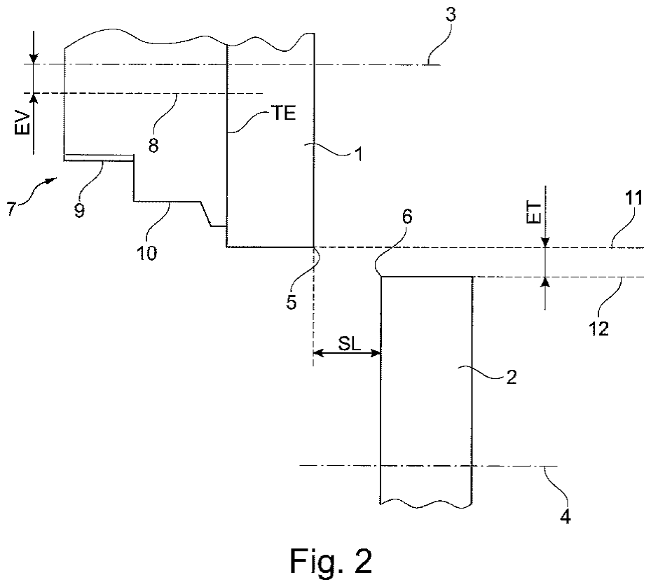

FIG. 2: is a further schematic partial view of the circular blades shown in FIG. 1 when viewing in the direction perpendicular to their axes of rotation;

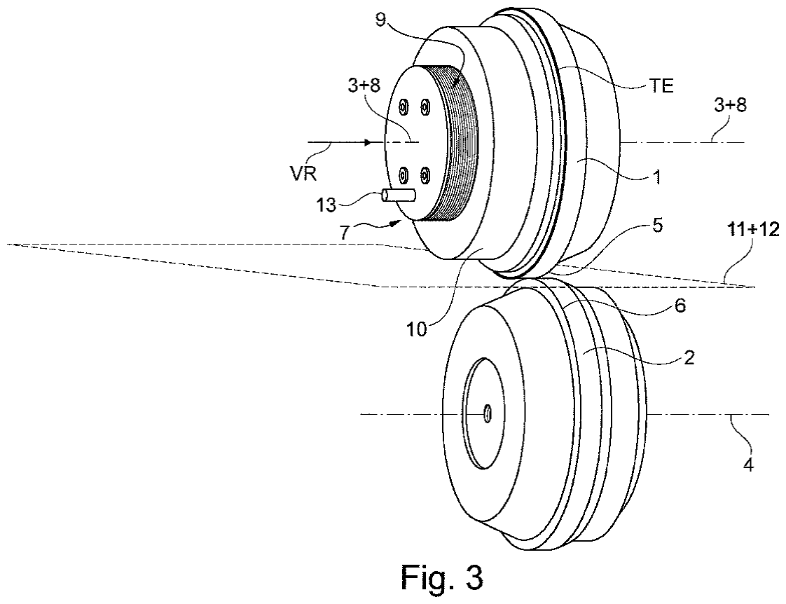

FIG. 3: is a schematic, perspective view similar to FIG. 1, in which a second relative position of the circular blades relative to each other is shown;

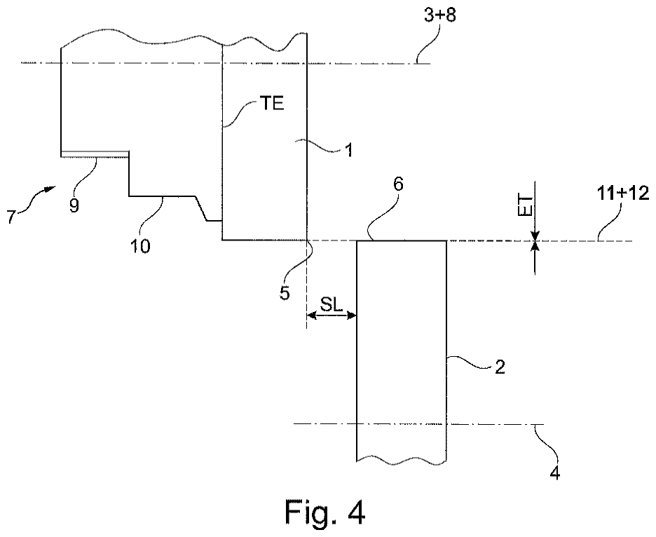

FIG. 4: is a further schematic partial view of the circular blades shown in FIG. 3 when viewing in the direction perpendicular to their axes of rotation;

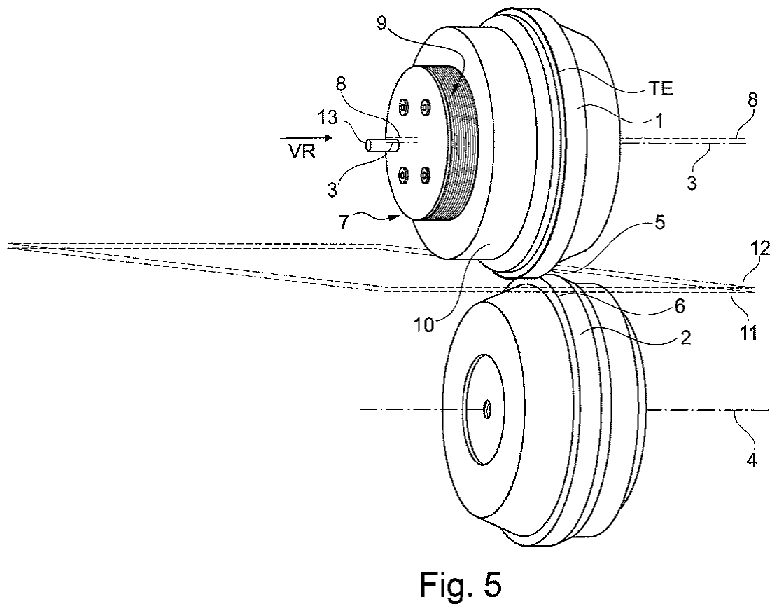

FIG. 5: is a schematic, perspective view similar to FIGS. 1 and 3, in which a third relative position of the circular blades relative to each other is shown; and

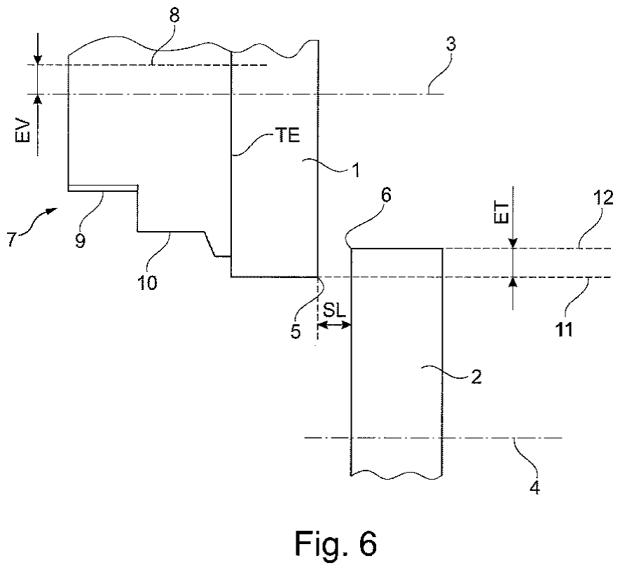

FIG. 6: is a further schematic partial view of the circular blades shown in FIG. 5 when viewing in the direction perpendicular to their axes of rotation.

A device according to the invention can be used in particular in connection with sheet metal bending machines. In this case, the device is used to cut off the sheet metal to be subsequently bent by the sheet metal bending machine and can be mounted in a linearly movable manner, for example on a motor-driven slide. With the help of the slide, the device for cutting the sheet metal is moved linearly along the intended cutting line. The two circular blades of the device are not actively driven in rotation, but rather passively rotate about their relevant axis of rotation solely due to the cutting reaction forces which act during the cutting process caused by the linear movement of the device along the cutting line.

The device for cutting sheet metal has a housing (not shown), in which there is a first circular blade 1 and a second circular blade 2, which are shown in FIG. 1. The lower, second circular blade 2 in FIG. 1 is mounted in the housing of the device so as to be passively rotatable about a second axis of rotation 4. The axis of rotation 4 is stationary in the housing, so that the circular blade 2 can rotate passively, but no further movement relative to the housing is possible.

The upper, first circular blade 1 in FIG. 1 is rotatably mounted on an eccentric element 7. The separating plane TE marks the separation between the circular blade 1 and the eccentric element 7.

The eccentric element 7 has a circumferential sliding bearing surface 10, with which it is rotatably mounted about an eccentric axis 8 and, in the longitudinal direction of the eccentric axis 8, is axially displaceably mounted in a bearing seat of the housing (not shown in FIG. 1). The eccentric element 7 has, concentrically relative to the sliding bearing surface 10, a thread 9 which is an external thread here. In the bearing seat on the housing side, the eccentric element 7 can rotate about the eccentric axis 8 and move axially along it, the eccentric axis 8, like the axis of rotation 4 of the second circular blade 2, being stationary relative to the housing of the device.

The first circular blade 1 is rotatable about a first axis of rotation 3 relative to the eccentric element 7 and relative to the housing of the device. As can be seen in FIG. 1, the axis of rotation 3 is offset relative to the eccentric axis 8 and arranged parallel thereto. The thread 9 is in engagement with a housing-side internal thread (not shown) against which it supports itself. By rotating the eccentric element 7, the axis of rotation 3 of the circular blade 1 is thus pivoted on a circular path around the eccentric axis 8, and the structural unit consisting of the eccentric element 7 and the circular blade 1 is linearly displaced in the direction of the eccentric axis 8. The circular blade 1 can be moved towards the second circular blade 2 or away from the second circular blade 2 in the direction of the eccentric axis 8 and in the direction perpendicular to the eccentric axis 8.

The first circular blade 1 has an annular, first blade edge 5, while the second circular blade 2 is provided with an annular, second blade edge 6. The lowest point of the blade edge 5 in FIG. 1 is in a first tangential plane 11. The uppermost point of the blade edge 6 in FIG. 1 is located in a second tangential plane 12.

FIG. 2 shows an enlarged partial view of the circular blades 1 and 2 shown in FIG. 1 in a viewing direction parallel to the planes spanned by the annular blade edges 5 and 6 (in the perspective of FIG. 1 from the front right). Identical reference signs denote identical parts to those in FIG. 1. The elements to be seen to the left and right of the circular blade 2 in FIG. 1 have been omitted from the illustration in FIG. 2 for the sake of simplicity.

In FIGS. 1 and 2, the axis of rotation 3 is located at its top dead centre relative to the eccentric axis 8, so that the actual dimension of the eccentric offset EV between the dashed eccentric axis 8 and the dash-dotted axis of rotation 3 can be seen in FIG. 2. Accordingly, the first tangential plane 11 is in its uppermost position above the tangential plane 12. The distance between the tangential planes 11 and 12 forms the so-called immersion depth ET, which in the relative position in the sense of FIG. 2 is as large as the eccentric offset EV. It is also mathematically negative since the blade edges 5 and 6 do not overlap each other in the vertical direction in FIG. 2 (first blade edge 5 does not dip into the second tangential plane 12).

In FIG. 2, the so-called cutting clearance SL is also drawn in, which denotes the distance between the plane spanned by the blade edge 5 and the plane spanned by the blade edge 6 in the viewing direction of the axes of rotation 3 and 4.

The immersion depth ET and the cutting clearance SL form parameters which are to be set in an optimal correlation to one another depending on the thickness of the sheet metal to be cut and, where necessary, on the material composition of the sheet metal to be cut. During the cutting process, the sheet metal (not shown) to be cut is located between the blade edges 5 and 6, and the circular blades 1 and 2 passively roll about their axes of rotation 3 and 4.

The relative position of the circular blades 1 and 2 shown in FIGS. 1 and 2 with maximum cutting clearance SL and maximum, negative immersion depth ET forms only a starting point for the setting of relative positions of the circular blades 1 and 2, which are actually used as working positions when cutting the sheet metal. To identify the rotational position of the eccentric element 7, a position pin 13 is attached thereto according to FIG. 1.

By rotating the eccentric element 7 by 90° in the viewing direction of FIG. 1 from left to right in a clockwise direction, the relative position of the circular blades 1 and 2 shown in FIGS. 3 and 4 is achieved, as can be seen from the position pin 13 in FIG. 3. Identical reference signs in FIGS. 3 and 4 denote identical parts, as in FIGS. 1 and 2.

Since the thread 9 supports itself, during the aforementioned rotation of the eccentric element 7, against a counter thread of the housing (not shown) of the device, the eccentric element 7 together with the first circular blade 1 moves to the right in FIGS. 1 and 2, which is indicated in FIG. 3 by the direction of displacement VR. Accordingly, the cutting clearance SL in FIG. 4 is smaller than the cutting clearance SL shown in FIG. 2, namely by a quarter of the pitch of the thread 9 (resulting from the rotation of the eccentric element 7 by) 90°.

This axial movement of the circular blade 1 or the blade edge 5 to the right along the eccentric axis 8 is overlaid by a movement of the circular blade 1 or the blade edge 5 in FIG. 2 downwards and out of the drawing plane in FIG. 2. This overlaid movement results from the rotary movement of the axis of rotation 3 by 90° on a quarter-circular path around the eccentric axis 8, the radius of the quarter-circular path being as large as the eccentric offset EV. As can be seen in FIG. 4, the eccentric axis 8 and the axis of rotation 3 lie exactly one behind the other in the viewing direction of FIG. 4, so that they are shown in FIG. 4 both as a dashed line (eccentric axis 8) and as a dash-dotted line (axis of rotation 3).

Starting from the position shown in FIG. 2, the circular blade 1 or the blade edge 5 has moved downwards by a distance which corresponds to the eccentric offset EV. The first tangential plane 11 or the lowest point of the blade edge 5 has thereby migrated into the second tangential plane 12, so that the lowest point of the blade edge 5 and the uppermost point of the blade edge 6 lie in the tangential planes 11 and 12 which coincide in FIGS. 3 and 4. The immersion depth ET in FIG. 4 is zero.

In FIGS. 5 and 6, a further relative position of the circular blades 1 and 2 with respect to one another is shown, which is achieved starting from the relative position shown in FIGS. 3 and 4 by rotating the eccentric element 7 by a further 90° about its eccentric axis 8, as can be seen with the position pin 13 drawn in FIG. 5. Identical reference signs in FIGS. 5 and 6 denote identical parts, as in FIGS. 1 and 4.

During the further rotary movement of the eccentric element 7 by 90°, it has moved again to the right by a quarter of the pitch of the thread 9 in accordance with the direction of displacement VR in FIG. 5, thereby taking the circular blade 1 with it by a corresponding distance. As a result, the cutting clearance SL has decreased once again by a quarter of the pitch of the thread 9, as can be seen qualitatively in FIG. 6.

At the same time, the axis of rotation 3 of the circular blade 1 has rotated a further 90° on the circular path about the eccentric axis 8, so that the circular blade 1 or the blade edge 5 in FIG. 6 has moved downward by the eccentric offset EV. The first blade edge 5 is immersed in the second tangential plane 12 of the second circular blade 2 by a distance which is as large as the eccentric offset EV. The first tangential plane 11 is now correspondingly far below the second tangential plane 12 in FIG. 6.

The blade edges 5 and 6 overlap one another in such a way that in FIG. 6 the lowest point of the blade edge 5 lies below the uppermost point of the blade edge 6 by the maximum immersion depth ET. Since the blade edge 5 is actually immersed in the tangential plane 12, the immersion depth ET in FIGS. 5 and 6 is mathematically positive. As in FIGS. 1 and 2, the immersion depth ET also corresponds to the maximum achievable amount of the eccentric offset EV in FIGS. 5 and 6.

If the eccentric element 7 is rotated, when viewed in FIG. 5 in a viewing direction from left to right, further clockwise, starting from its position shown in FIGS. 5 and 6, the immersion depth ET initially decreases again, while at the same time the cutting clearance SL is further reduced. After a rotation of the eccentric element by 270°, the immersion depth ET of zero shown in FIGS. 3 and 4 is finally achieved again with a progressive reduction in the cutting clearance SL. If the eccentric element 7 continues to rotate up to a full rotation of 360°, the maximum negative immersion depth ET shown in FIGS. 1 and 2 will again be set at the amount of the eccentric offset while the cutting clearance SL continues to reduce.

Of course, any intermediate relative positions of the circular blades 1 and 2 can be set which do not correspond to the relative positions shown by way of example in FIGS. 1 to 6. The intermediate relative positions result from rotations of the eccentric element 7 by angles between 0° and 90°, between 90° and 180°, between 180° and 270° and between 270° and 360°.

The rotation of the eccentric element 7 about the eccentric axis 8 takes place with the aid of a single servo motor which, with a drive element (not shown), can at least temporarily engage in the end face of the eccentric element 7 seen in FIGS. 1, 3 and 5, from which the position pin 13 protrudes.

The size of the eccentric offset EV, the size of the pitch of the thread 9 and the geometric relative starting position of the circular blades 1 and 2, which is shown in FIGS. 1 and 2, define the positive coupling according to the invention between the cutting clearance SL and the immersion depth ET. In the electronic machine control of the system, for example a sheet metal bending machine, in which the device for cutting sheet metal according to the invention is used, each thickness of the sheet metal to be cut can be assigned a very specific rotational position of the eccentric element 7. The alignment of the cutting clearance SL and immersion depth ET parameters to the thickness of the sheet metal to be cut is therefore much more reliable with regard to the correct correlation of cutting clearance SL and immersion depth ET and, moreover, can be carried out in a greatly simplified manner.

### LIST OF REFERENCE SIGNS

1 First circular blade

2 Second circular blade

3 First axis of rotation

4 Second axis of rotation

5 First blade edge

6 Second blade edge

7 Eccentric element

8 Eccentric axis

9 Thread of the eccentric element 7

10 Sliding bearing surface

11 First tangential plane

12 Second tangential plane

13 Position pin

ET Immersion depth

EV Eccentric offset

SL Cutting clearance

TE Separating plane between eccentric element 7 and circular blade 1

VR Direction of displacement of the eccentric element 7

1. A device for cutting sheet metal comprising:
a first circular blade having a first blade edge and a second circular blade having a second blade edge;
wherein the sheet metal to be cut is positioned between the first circular blade and the second circular blade during cutting;
wherein the first circular blade is rotatably mounted about a first axis of rotation and the second circular blade is rotatably mounted about a second axis of rotation which runs parallel to the first axis of rotation;
wherein a position of the first circular blade relative to the second circular blade is adjustable, and wherein a distance between the first circular blade and the second circular blade is defined by a cutting clearance by which the first blade edge is axially spaced apart from the second blade edge in the direction of the first axis of rotation, and by an immersion depth by which the first blade edge and the second blade edge radially overlap each other in a direction perpendicular to the axes of rotation; and
wherein there is a positive coupling between the cutting clearance and the immersion depth for adjusting the distance between the first circular blade and second circular blade such that, when a specific cutting clearance is set, a predetermined immersion depth is also.

2. A device according to claim 1, wherein the first circular blade is rotatably mounted on a linearly movable eccentric element having an eccentric axis; and
wherein the first axis of rotation has an eccentric offset relative to the eccentric axis and the eccentric element is provided with a thread which is concentric with the eccentric axis for linear movement of the eccentric element, such that a linear movement of the eccentric element for setting the specific cutting clearance by rotating the eccentric element is associated with a rotation of the first axis of rotation about the eccentric axis and thus with the setting of the predetermined immersion depth.

3. A device according to claim 2, wherein the thread is an external thread.

4. A device according to claim 2, further comprising a single servo motor for rotating the eccentric element for setting both the specific cutting clearance and the predetermined immersion depth.

5. A device according to claim 3, further comprising a single servo motor for rotating the eccentric element and thus for setting both the specific cutting clearance and the predetermined immersion depth.

6. A device according to claim 1, wherein when a specific immersion depth is set, a predetermined cutting clearance is also set.
